(19) United States
(12) Patent Application Publication
(10) Pub. No.: US 2025/0144660 A1
(43) Pub. Date: May 8, 2025

(54) TRUE LOCATION AND ORIENTATION ACQUISITION DEVICE FOR LAND ROBOTS

(71) Applicant: ISTANBUL TEKNIK UNIVERSITESI, Istanbul (TR)

(72) Inventors: Volkan SEZER, Istanbul (TR); Ahmet KAGIZMAN, Istanbul (TR)

(73) Assignee: ISTANBUL TEKNIK UNIVERSITESI, Istanbul (TR)

(21) Appl. No.: 18/878,085

(22) PCT Filed: Jun. 9, 2023
(86) PCT No.: PCT/TR2023/050544

§ 371 Date: Dec. 23, 2024

(30) Foreign Application Priority Data
Jun. 10, 2022 (TR) 2022/009641

(51) Int. Cl. B05C 1/06

(52) U.S. Cl. CPC B05C 1/06

(57) ABSTRACT

A single-unit device does not require any additional installation, can be easily mounted on the robot to be used, and obtains real location and orientation information of land robots. The device includes a pinion gear, a rack gear, a motor, an upper vertical arm, a clamping chuck, a clamping chuck lock collar, a lower vertical arm, a clamping chuck collar, a bevel gear, a chuck body, and a marker.

### CROSS REFERENCE TO THE RELATED APPLICATIONS

This application is the national phase entry of International Application No. PCT/TR2023/050544, filed on Jun. 9, 2023, which is based upon and claims priority to Turkish Patent Application No. 2022/009641, filed on Jun. 10, 2022, the entire contents of which are incorporated herein by reference.

### TECHNICAL FIELD

The invention relates to a device for obtaining true location and orientation information of autonomous land robots simply and at low cost.

More particularly, the invention relates to a single-unit device that does not require any additional installation, can be easily mounted on the robot to be used, and obtains the actual location and orientation information of land robots.

### BACKGROUND

Localization in robots, that is, the problem of understanding the position of the robot on the map, is one of the most fundamental problems of autonomous robots. In land robots, the position of the robot consists of x-y coordinates on the map and orientation information (xᵣ, yᵣ, θᵣ). In order to analyze how well the robot makes this prediction, it is necessary to obtain ground truth information about where the robot is actually located on the map and at what angle. The localization algorithms developed can only be tested in this way and the accuracy of the prediction can be analyzed.

Obtaining real location information in robot systems was realized by taking simultaneous images from multiple cameras and processing these images. With this process, location information can be obtained in 6 axes, including x-y-z and the angles in each axis, including flying robots. In land robots, however, location information in 3 axes (xᵣ, yᵣ, θr) is sufficient for the majority of applications.

In the United States patent document numbered US20160044217A1, which is in the known state of the art, a special camera designed to determine the location of an object and a motion capture system created by using more than 1 of these cameras are mentioned. The location of the object in 3D space can be calculated by simultaneously detecting the markers to be placed on the object whose location is to be calculated by different cameras.

The European patent document EP1717660A2 in the known state of the art mentions a mobile robot that can accurately calculate the location of the wireless signal source using the wireless signal and allow the mobile robot to accurately and quickly return to the charging stand using the calculated location. The location finding system for the mobile robot includes a wireless signal source, a directional antenna for detecting the signal.

The Chinese patent document CN106959697A, which is in the known state of the art, mentions an indoor mapping construction system in a straight corridor environment. The system consists of a robot body, a vision acquisition device, an automatic telescopic arm, a laser range finder, and a controller. The special feature of the system is that the visual acquisition device is mounted on the robot body with the help of an automatic telescopic arm. The controller determines whether the robot enters the long straight corridor environment with the depth information obtained by the laser range finder.

The U.S. Pat. No. 10,102,429B2, which is in the known state of the art, mentions an autonomous robot comprising a driver configured to maneuver the robot over a floor. A camera with a ground field of view is mounted on the robot. There is a buffer that stores the images. It includes a drive motor.

In the International patent document numbered WO2007051972A1, which is in the known state of the art, it is mentioned the navigation system that can be used in mobile robotic devices, which includes a primary mapping apparatus adapted to detect features within an environment and to create a summary map of the environment including an estimate of a point of the current location within the environment, a secondary mapping device, and a processor for determining navigable points within the environment by combining information from the detailed map.

In the European patent document numbered EP3656513A1, which is in the known state of the art, the data processing system and method used to predict the motion trajectory of a robot moving in a certain location is mentioned.

However, the devices and robots in the art do not have a simple and low-cost single-unit device that can be easily mounted on the robot it will be used in, and that obtains the actual location and orientation information of land robots. Therefore, there was a need to develop the inventive device.

### SUMMARY

The object of the present invention is to realize a device for obtaining the true location and orientation information of land robots in a simple and low-cost way.

Another object of the present invention is to realize a single-unit device that does not require any additional installation, can be easily mounted on the robot to be used, and obtains the actual location and orientation information of land robots.

Another object of this invention is the realization of a device that enables the real robot localization problem, which is one of the most basic problems of autonomous land robots, to be solved by means of an apparatus to be attached directly to the land robot, and to obtain the real robot location and orientation with a trace to be physically left on the ground. Autonomous robots, in order to perform their tasks, need to calculate the location information on the map in the most accurate way (localization problem). The developed device will be used to obtain location/orientation information (ground truth) necessary to analyze the solution to the localization problem, which is one of the most fundamental problems of autonomous land robots. In this way, it will be possible to analyze how inaccurate the location information calculated by the robot is in reality. With the help of an apparatus to be attached directly to the land robot, it will be possible to obtain the actual robot location and orientation by physically leaving a trace on the ground. The actual location and orientation information of the track to be left can be obtained by manual measurements to be performed later. In this way, direct measurements will be made instead of indirectly obtaining the actual location/angle. Since it will be a system that can be easily mounted on the robot, there will be no installation complexity. It will have a low-cost structure. It will be applicable to different robots. Since the trace will be left directly on the ground, it will work independently of problems such as the robot not being visible from above as in the previous technique.

### BRIEF DESCRIPTION OF THE DRAWINGS

A real location and orientation acquisition device for land robots realized to achieve the objects of the present invention is shown in the attached figures.

FIG. 1 is a schematic view of the real location and orientation acquisition device for the land robots of the invention.

FIG. 2 is a schematic view of the real location and orientation acquisition device for the land robots of the invention from different angles.

FIG. 3 is a schematic vertical cross-sectional view of the real location and orientation acquisition device for the land robots of the invention.

FIG. 4 is a schematic view of the rack gear in the inventive device.

FIG. 5 is a schematic view of the pinion gear in the inventive device.

FIG. 6 is a schematic view of the body of the inventive device.

FIG. 7 is a schematic view of the upper vertical arm of the inventive device.

FIG. 8 is a schematic view of the clamping chuck lock collar in the inventive device.

FIG. 9 is a schematic view of the clamping chuck in the inventive device.

FIG. 10 is a schematic view of the lower vertical arm of the inventive device.

FIG. 11 is a schematic view of the clamping chuck collar in the inventive device.

FIG. 12 is a schematic view of the bevel gear in the inventive device.

FIG. 13 is a schematic view of the chuck body in the inventive device.

FIG. 14 is a schematic view of the bevel chuck wrench in the inventive device.

FIG. 15 is a schematic view of the holder cover in the inventive device.

FIG. 16 is a schematic view of the chuck jaw in the inventive device.

The parts in the figures are individually numbered and the corresponding numbers are given below.
1. Body
2. Pinion gear
3. Rack gear
4. Motor
5. Upper vertical arm
6. Clamping chuck
7. Clamping chuck lock collar
8. Lower vertical arm
9. Clamping chuck collar
10. Bevel gear
11. Chuck body
12. Marker
13. Bevel chuck wrench
14. Holder cover
15. Fastener
16. Spring
17. Chuck jaw

### DETAILED DESCRIPTION OF THE EMBODIMENTS

The invention is a device that enables the real robot location and orientation to be obtained with a trace to be physically left on the ground with the help of an apparatus to be attached directly on the land robot, and comprises the following elements;
A pinion gear (2) in the body (1), which provides the circular motion,
a rack gear (3) connected to the pinion gear (2), which is used to convert circular motion into vertical motion,
a motor (4) connected to the pinion gear (2), which allows the system to be moved up and down in a certain distance,
telescopic upper vertical arm (5) connected to a rack gear (3), providing a wide height range so that the system can be used on many autonomous land robots of different sizes,
clamping chuck (6) located on the upper vertical arm (5), used to adjust to the desired level,
clamping chuck lock collar (7), which is connected with the upper vertical arm (5) and the clamping chuck (6), used to fix the clamping chuck (6) at the desired level,
telescopic lower vertical arm (8), which is connected to the upper vertical arm (5) by a clamping chuck (6), allowing the height to be adjusted,
clamping chuck collar (9) connected to the lower vertical arm (8), through which the rotary movement will be provided,
bevel gear (10) connected to the clamping chuck collar (9), through which the movement will be provided,
chuck body (11) with slots inside, connected to the bevel gear (10),
marker (12) connected to the chuck body (11), for tracing on the ground,
bevel chuck wrench (13), connected to the chuck body (11), which is inserted into the slots in the chuck body (11) and rotated clockwise together with the clamping chuck collar (9) and the bevel gear (10), thereby clamping the marker (12),
holder cover (14) connected to the chuck body (11), which prevents the lower vertical arm (8) from disengaging from the chuck body (11),
fasteners (15) for fixing the upper vertical arm (5) to the rack gear (3) and the holder cover (14) to the chuck body (11),
a spring (16) between the lower vertical arm (8) and the chuck body (11), which is used to prevent the marker (12) from touching the ground hard,
3-piece chuck jaws (17) in the chuck body (11), which allows the marker (12) to be tightened by means of the movement provided by the bevel chuck wrench (13).

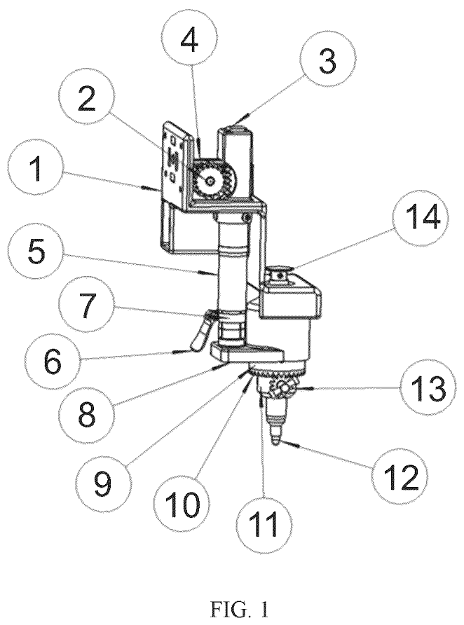

The actual location and orientation acquisition device for the developed land robots consists of a spur rack gear (3), a motor (4), a pinion gear (2), a body (1), a telescopic upper vertical arm (5), a clamping chuck lock collar (7), one clamping chuck (6), one telescopic lower vertical arm (8), one clamping chuck collar (9), one bevel gear (10), one chuck body (11), one marker (12), one bevel chuck wrench (13), one holder cover (14) (FIG. 1).

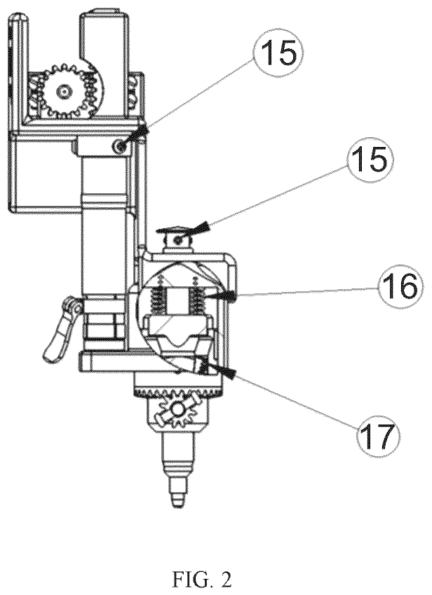

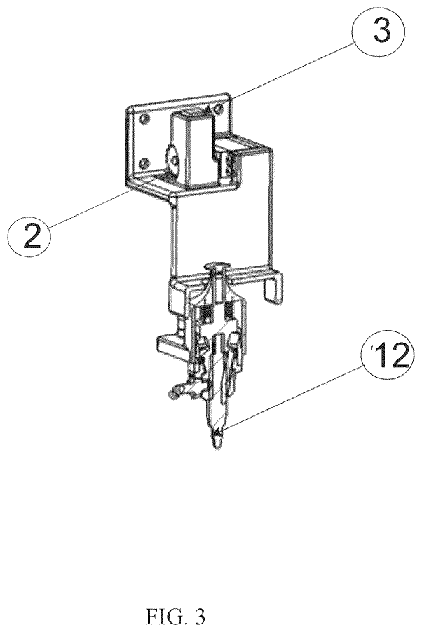

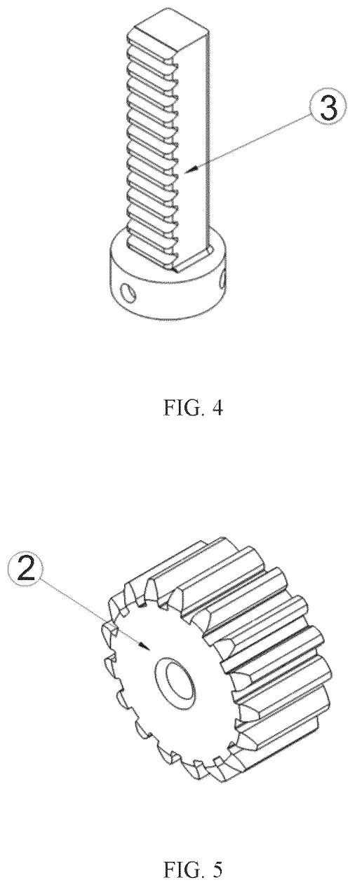

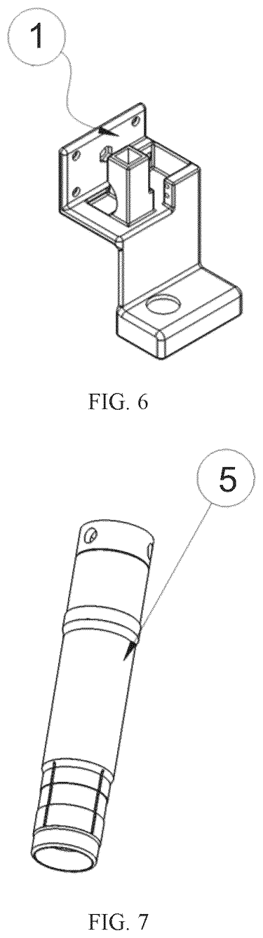

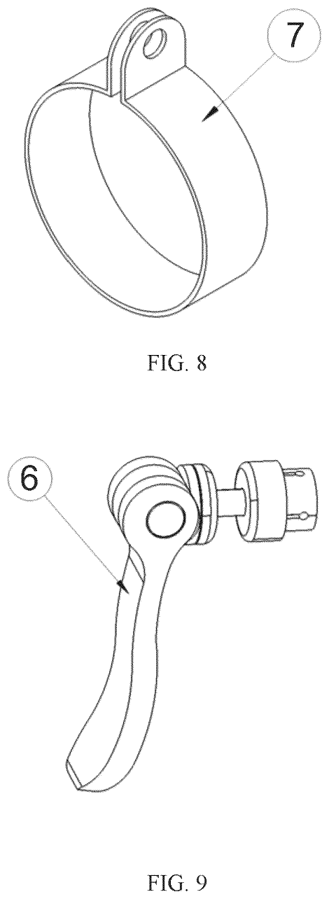

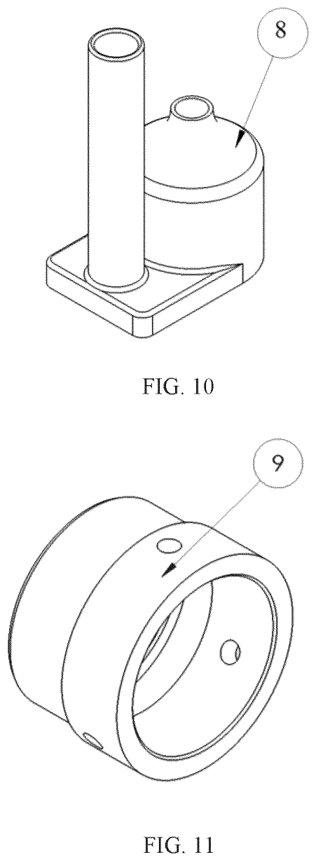

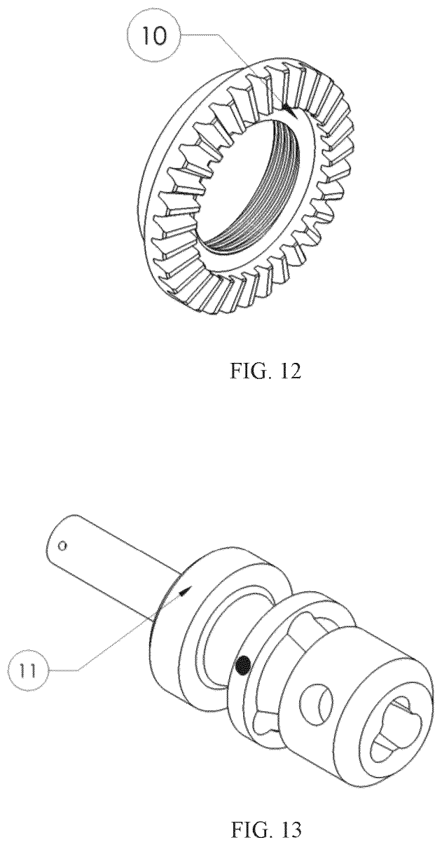

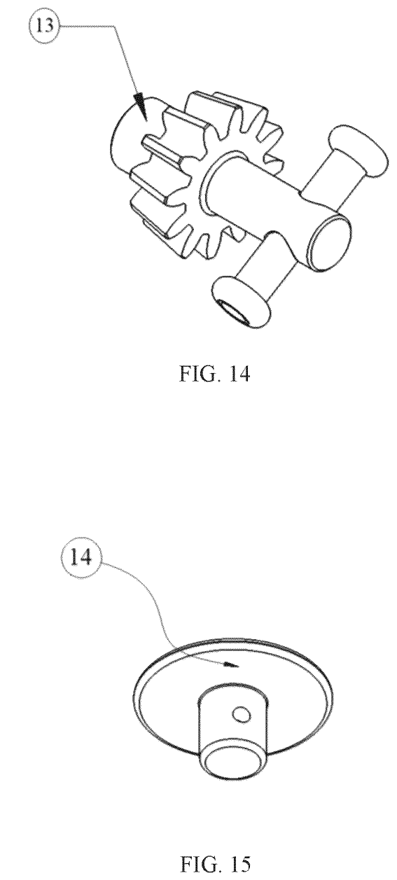

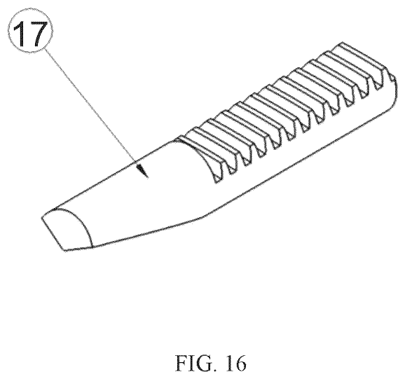

In FIG. 2, fasteners (15), a spring (16), and 3-piece chuck jaws (17), which are also among the equipment of the device, are shown.

In the developed device, the motor (4) triggers the pinion gear (2). The pinion gear (2), which makes circular motion, works in coupling with the spur rack gear (3) and converts the circular motion into vertical motion. A telescopic vertical arm mechanism consisting of a telescopic upper vertical arm (5) and a telescopic lower vertical arm (8) has been designed so that the device can be used in autonomous land robots at different heights. The upper vertical arm fastener (15) is fixed to the spur rack gear. The lower vertical arm (8) can be fixed to the upper vertical arm (5) at the desired level by closing the clamping chuck (6) lever and consequently reducing the diameter of the clamping chuck lock collar (7). Similarly, by opening the clamping chuck (6) lever, the clamping chuck lock collar (7) is loosened and the upper vertical arm (5) and the lower vertical arm (8) are no longer in contact.

A diameter adjustment mechanism similar to a drill chuck is integrated into the device to enable the use of different diameters of markers (12) that allow marks to be left on the ground. The bevel chuck wrench (13) is inserted into one of the slots in the chuck body (11) and manually rotated clockwise by the bevel gear (10), which is connected by an interference fit with the clamping chuck collar (9). This rotation closes the chuck jaws (17) in the chuck body (11) and tightens the marker (12). Similarly, if the rotation is counterclockwise, this time the chuck jaws (17) is opened and the marker (12) is released.

During the movement of the robot, the marker (12) in the device should not touch the ground hard in order not to disrupt the movement. For this purpose, a spring (16) is placed between the lower vertical arm (8) and the chuck body (11), which are telescopically connected to each other. In order to prevent the lower vertical arm (8) from detaching from the chuck body (11), fasteners (15) and a holder cover (14) are integrated in the chuck body (11).

The body (1), which is the part on which the motor (4) and electronic control units are mounted, is designed to be fixed to all types of autonomous land vehicles.

What is claimed is:

1. A device for obtaining an actual robot location and an actual robot orientation by an apparatus to be attached directly to a land robot, by a trace to be physically left on ground, comprising:
a pinion gear located in a body, wherein the pinion gear provides a circular motion,
a rack gear connected to the pinion gear, wherein the rack gear is used to convert the circular motion into a vertical motion,
a motor connected to the pinion gear, wherein the motor allows a system to be moved in up-and-down directions over a predetermined distance,
an upper vertical arm connected to the rack gear, wherein the upper vertical arm provides a wide range of heights so that the system is configured to be used on a plurality of autonomous land robots of different sizes,
a clamping chuck located on the upper vertical arm and used to adjust the upper vertical arm to a desired level,
a clamping chuck lock collar, connected to the upper vertical arm and the clamping chuck, and used to fix the clamping chuck at the desired level,
a lower vertical arm, wherein the lower vertical arm is connected to the upper vertical arm by the clamping chuck, allowing the height to be adjusted,
a clamping chuck collar connected to the lower vertical arm, wherein a rotary movement is provided through the clamping chuck collar,
a bevel gear connected to the clamping chuck collar, wherein a movement is provided through the bevel gear,
a chuck body with slots inside, connected to the bevel gear, and
a marker connected to the chuck body, wherein the marker allows tracing on the ground.

2. The device according to claim 1, further comprising a bevel chuck wrench connected to the chuck body, wherein the bevel chuck wrench is inserted into the slots in the chuck body and rotated clockwise by the clamping chuck collar and the bevel gear, wherein the bevel chuck wrench clamps the marker.

3. The device according to claim 1, further comprising a holder cover connected to the chuck body, wherein the holder cover prevents the lower vertical arm from disengaging from the chuck body.

4. The device according to claim 1, further comprising fasteners for securing the upper vertical arm to the rack gear and a holder cover to the chuck body.

5. The device according to claim 1, further comprising a spring between the lower vertical arm and the chuck body for preventing the marker from coming into hard contact with the ground.

6. The device according to claim 1, further comprising 3-piece chuck jaws for tightening the marker by a movement provided by a bevel chuck wrench located in the chuck body.

7. The device according to claim 2, further comprising a holder cover connected to the chuck body, wherein the holder cover prevents the lower vertical arm from disengaging from the chuck body.

8. The device according to claim 2, further comprising fasteners for securing the upper vertical arm to the rack gear and a holder cover to the chuck body.

9. The device according to claim 3, further comprising fasteners for securing the upper vertical arm to the rack gear and the holder cover to the chuck body.

10. The device according to claim 2, further comprising a spring between the lower vertical arm and the chuck body for preventing the marker from coming into hard contact with the ground.

11. The device according to claim 3, further comprising a spring between the lower vertical arm and the chuck body for preventing the marker from coming into hard contact with the ground.

12. The device according to claim 4, further comprising a spring between the lower vertical arm and the chuck body for preventing the marker from coming into hard contact with the ground.

13. The device according to claim 2, further comprising 3-piece chuck jaws for tightening the marker by a movement provided by the bevel chuck wrench located in the chuck body.

14. The device according to claim 3, further comprising 3-piece chuck jaws for tightening the marker by a movement provided by a bevel chuck wrench located in the chuck body.

15. The device according to claim 4, further comprising 3-piece chuck jaws for tightening the marker by a movement provided by a bevel chuck wrench located in the chuck body.

16. The device according to claim 5, further comprising 3-piece chuck jaws for tightening the marker by a movement provided by a bevel chuck wrench located in the chuck body.
